(19) United States
(12) Patent Application Publication
(10) Pub. No.: US 2025/0393038 A1
(43) Pub. Date: Dec. 25, 2025

(54) SYSTEMS FOR EXTENDING RANGE OF A BASE STATION VIA A BACKHAUL NETWORK

(71) Applicant: VTech Telecommunications Limited, Hong Kong (CN)

(72) Inventors: Joe Kin Shing Lee, Hong Kong (CN); Argus Chi Wai Wong, Hong Kong (CN)

(21) Appl. No.: 18/749,045

(22) Filed: Jun. 20, 2024

(51) Int. Cl. H04W 72/0453; H04M 1/71; H04W 88/06

(52) U.S. Cl. CPC H04W 72/0453; H04M 1/71; H04W 88/06

(57) ABSTRACT

A digital cordless telecommunication system includes a first base station having a first transceiver configured to transmit and receive voice and data packets, using a cordless telecommunication frequency band, between the first base station and a first set of handsets. The first base station further includes a second transceiver configured to transmit and receive, via a backhaul network, to at least one other base station configured to transmit and receive the voice and data packets using the cordless telecommunication frequency band. The first base station further includes one or more processors operatively coupled to the first transceiver and the second transceiver to control transmitting and receiving of the voice and data packets. The first base station also includes a call control processor operatively coupled to the processors, the call control processor controlling communication between the first base station and a local area network (LAN).

### BACKGROUND

### TECHNICAL FIELD

This invention relates generally to Digital Enhanced Cordless Telecommunications (DECT) systems, and more specifically to architectures and methods for extending the device capacity of DECT base stations through interconnected networks.

### DESCRIPTION OF THE RELATED ART

The DECT standard is a widely used technology for providing wireless voice and data communication services between handsets (e.g. wireless terminals) and fixed base stations. DECT operates at frequencies in the vicinity of 2 GHz, e.g., 1.18 GHz to 2.025 GHz, and uses time division multiple access (TDMA) to transmit digitized voice and data over separate time slots. The DECT standard provides robust voice quality, low power consumption, and seamless handover between base stations as users move between coverage areas.

In order to extend the range of DECT coverage beyond what a single base station can provide, DECT systems commonly employ wireless repeaters. Repeaters receive the DECT radio signals, amplify them, and rebroadcast them to expand the coverage range. The base stations are typically connected together via wired local area networks (LANs) to enable seamless roaming of portable DECT-enabled devices across multiple base station coverage areas.

However, a key limitation in traditional DECT installations is the maximum number of concurrent calls (e.g. voice calls, data sessions, etc.) that a single base station can support, which is generally ranges from around five to twelve calls. In a typical case, the base station may be capable of supporting up to 10 narrowband, duplex call channels, two of which may be reserved for handover/roaming functions, leaving 8 available call channels. In addition, one or more channels of the base station may be needed to provide a link to a repeater. According to DECT repeater operations, the call setup between a repeater and a corresponding base station is a duplex channel. Therefore, when a handset establishes a narrowband call to a base station via a repeater, the repeater is required to establish two duplex call channels: one to the base station and one to the handset. This means that a typical repeater can only support up to 5 narrowband calls (assuming there are 10 available channels). Also, the total number of calls for a base station in conjunction with one or more repeaters cannot exceed the total number of supported channels for the base station itself (e.g., 8 calls).

Thus, while adding a repeater to a base station extends the coverage range, it does not increase the maximum number of active calls which can be handled by the base station. These capacity constraints diminish many of the range extension benefits provided by DECT repeaters, as the increased coverage areas can only be effectively used by a limited number of devices at any given time. As DECT systems are deployed across enterprises, buildings, and campuses, this restriction on the number of concurrent active communication links presents a significant limitation on system scalability.

### SUMMARY

In one aspect, disclosed embodiments are directed to a system for communicating with digital cordless telecommunication handsets. The system includes a first base station that includes a first transceiver configured to transmit and receive voice and data packets, using a cordless telecommunication frequency band, between the first base station and a first set of handsets within a coverage area of the first base station, the first base station providing up to a defined maximum number of cordless telecommunication handset connections. The first base station also includes a second transceiver configured to transmit and receive the voice and data packets, via a backhaul network, to at least one other base station configured to transmit and receive the voice and data packets using the cordless telecommunication frequency band. The first base station further includes one or more processors operatively coupled to the first transceiver and the second transceiver to control transmitting and receiving of the voice and data packets by the first transceiver and the second transceiver. The base station further includes a call control processor operatively coupled to said one or more processors, the call control processor controlling communication between the first base station and a local area network (LAN).

Embodiments may include one or more of the following features, individually or in combination.

The second transceiver of the first base station may be configured to wirelessly transmit and receive the voice and data packets via the backhaul network using a different frequency band than the cordless telecommunication frequency band.

The second transceiver of the first base station may be configured to wirelessly transmit and receive the voice and data packets via the backhaul network using a communication technology different from a communication technology used by the first transceiver of the first base station.

The one or more processors of the first base station may include a first processor operatively coupled to the first transceiver of the first base station and configured to control transmitting and receiving of the voice and data packets by the first transceiver of the first base station. The one or more processors of the first base station may also include a second processor operatively coupled to the second transceiver of the first base station and configured to control transmitting and receiving of the voice and data packets by the second transceiver of the first base station.

The second transceiver of the first base station may be configured to communicate using any one of the following communication technologies: cordless telecommunication, cordless telecommunication NR+, BLE, 900 MHz, 2.4 GHz, and 5.8 GHz FHSS. The defined maximum number of cordless telecommunication handset connections may be between 5 and 12, inclusively. The one or more processors may use a codec to compress and decompress the voice and data packets. The codec may be any one of: G.722, AMR-WB, OPUS, SILK, LC3, LC3+, G.729, etc.

The call control processor may be a session initiation protocol (SIP) processor. The first transceiver of the first base station and the second transceiver of the first base station may be formed physically and/or functionally as an integrated transceiver.

The system may further include at least a second base station configured to transmit and receive the voice and data packets, using the cordless telecommunication frequency band, between said at least second base station and a corresponding set of handsets within a coverage area of said at least second base station, said at least second base station being further configured to transmit and receive the voice and data packets, using the backhaul network, between the first base station and said at least second base station.

The first base station may provide connectivity to any handset in the first set of handsets and said corresponding set of handsets.

The first base station may be configured to connect to a target handset of said corresponding set of handsets via the backhaul network and said at least second base station when the target handset is within the coverage area of said at least second base station, and connect to the target handset using the cordless telecommunication frequency band when the target handset moves within the coverage area of the first base station. The second transceiver of the first base station may be configured to transmit and receive the voice and data packets via the backhaul network using a wired connection between the first base station and said at least second base station.

The at least second base station provides up to a defined maximum number of cordless telecommunication handset connections. The first base station provides a total number of handset connections up to the defined maximum number of cordless telecommunication handset connections of the first base station plus the defined maximum number of cordless telecommunication handset connections of said at least second base station.

The one or more processors of the first base station may be further configured to compress and decompress voice and data packets for communication between the second transceiver of the first base station and said at least second base station via the wireless backhaul network.

The at least second base station may include a plurality of base stations configured to transmit and receive the voice and data packets, using the cordless telecommunication frequency band, between each base station of said plurality of base stations and a respective corresponding set of handsets within a coverage area of each base station of said plurality of base stations, each base station of said plurality of base stations being further configured to transmit and receive the voice and data packets, using the backhaul network, between each base station of said plurality of base stations and the first base station.

The at least second base station may include a plurality of base stations connected in series and configured to transmit and receive the voice and data packets, using the cordless telecommunication frequency band, between each base station of said plurality of base stations and a respective corresponding set of handsets within a coverage area of each base station of said plurality of base stations, each base station of said plurality of base stations being further configured to transmit and receive the voice and data packets, using the backhaul network, between each base station of said plurality of base stations and a neighboring one of said plurality of base stations.

The at least second base station may include a first transceiver configured to transmit and receive voice and data packets, using the cordless telecommunication frequency band, between said at least second base station and said corresponding set of handsets. The at least second base station may further include a second transceiver configured to transmit and receive the voice and data packets, via the backhaul network, to at least one other base station configured to transmit and receive the voice and data packets using the cordless telecommunication frequency band. The at least second base station may also include one or more processors operatively coupled to the first transceiver and the second transceiver to control transmitting and receiving of the voice and data packets by the first transceiver and the second transceiver.

The at least second base station may further include a call control processor operatively coupled to said one or more processors of said at least second base station, the call control processor of said at least second base station controlling communication between said at least second base station and a local area network (LAN).

### BRIEF DESCRIPTION OF THE DRAWINGS

FIG. 1 depicts a set of equipment for a Digital Enhanced Cordless Telecommunications (DECT) system including a multi-cell base station and a number of wireless terminals.

FIG. 2 depicts a primary base station and a number of secondary base stations of a DECT multi-cell system, each of which is responsible for communicating with wireless terminals.

FIG. 3 depicts a multicell DECT system with a base station configured to communicate with a DECT repeater.

FIG. 4 depicts a multicell DECT system with a daisy-chained configuration of repeaters.

FIGS. 5 depicts an embodiment of a DECT multicell system comprising a base station configured to communicate with a DECT router via a backhaul network.

FIG. 6 depicts an embodiment of a multicell DECT system with a daisy-chained configuration of DECT routers connected to a base station via a backhaul network.

FIG. 7 depicts an embodiment of a base station 718 configured to connect to DECT routers via a backhaul network.

FIG. 8 depicts a DECT router configured to connect to a base station and other DECT routers via a backhaul network.

### DETAILED DESCRIPTION

Reference will now be made in detail to the embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications, and equivalents that may be included within the scope of the invention as defined by the appended claims. Furthermore, in the following detailed description, numerous specific details are set forth to provide a thorough understanding of the present invention. However, it will be understood by those of ordinary skill in the art that the present invention may be practiced without these specific details. In other instances, well-known methods, procedures, components, and circuits have not been described in detail so as not to unnecessarily obscure aspects of the present invention.

Digital Enhanced Cordless Telecommunications (DECT) is a standard that primarily describes the wireless connection between cordless phones and their base stations. DECT uses Time Division Multiple Access (TDMA) to allow multiple handsets to communicate with the base station simultaneously. It divides the communication channel into multiple time slots, and each handset is assigned a specific time slot in which to transmit and receive information.

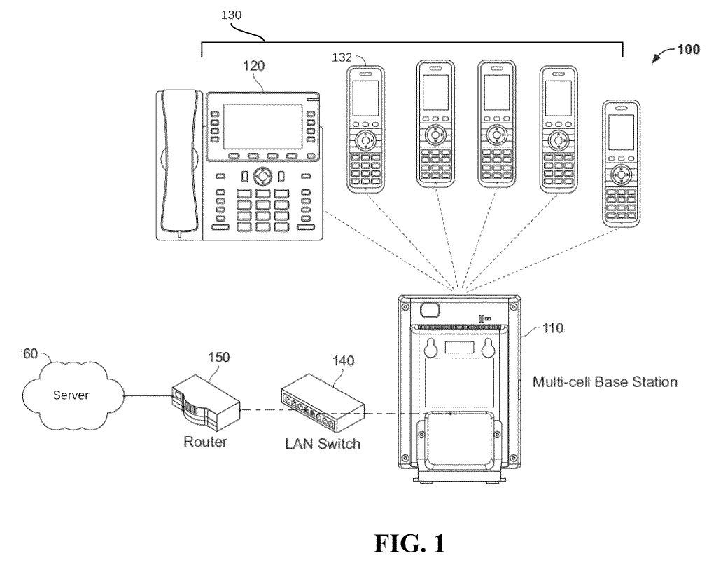

FIG. 1 depicts a set of equipment 100 for a DECT system including a multi-cell base station 110 and a number of wireless terminals 130. In the example depicted, the base station 110 is set up to communicate with a cordless deskset 120 and a number of cordless handsets 132. In some cases, the base station 110 may be connected to a wired local area network (LAN) switch 140, which is in communication with a router 150. The router 150, in turn, may be connected to a server 160, e.g., an external or end Voice Over Internet Protocol (VoIP) server. Additionally, the router 150 may be connected to other types of servers, such as a hosted Internet Protocol (IP) private branch exchange (PBX) (not shown) which provides access to the public switched telephone network.

In embodiments, there are multiple base stations 110 and wireless communication terminals 130, which may roam among base stations 110 during operation. One base station may be set up as a primary base station and all other base stations may be set up as secondary base stations.

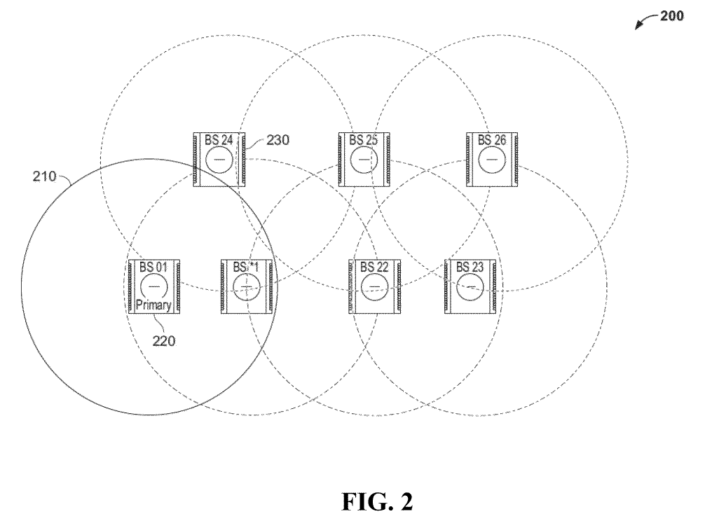

FIG. 2 depicts a primary base station 220 and a number of secondary base stations 230 of a DECT multi-cell system 200, each of which is responsible for communicating with wireless terminals 130 (see FIG. 1), e.g., cordless handsets, within a specific area or “cell” 210. Each cell 210 overlaps with the neighboring cells to ensure there are no gaps in coverage.

When a wireless terminal 130 is first used in the system 200, it is registered with the base stations (220, 230), which record its unique ID. Generally, when the wireless terminal 130 makes a call, the closest base station (220, 230) sets up the call, i.e., the base station (220, 230) to which the wireless terminal 130 is “localized.” This process is facilitated through a frequency/time slot pattern, with each base station (220, 230) and handset pairing given a unique pattern to avoid interference. As a wireless terminal 130 moves from the coverage area, i.e., cell 210, of one base station (220, 230) to another, the system performs a handover. This involves the base station with a weakening signal handing over the connection to the base station where the signal is getting stronger. This process is seamless to the user, who does not experience any interruption in their call.

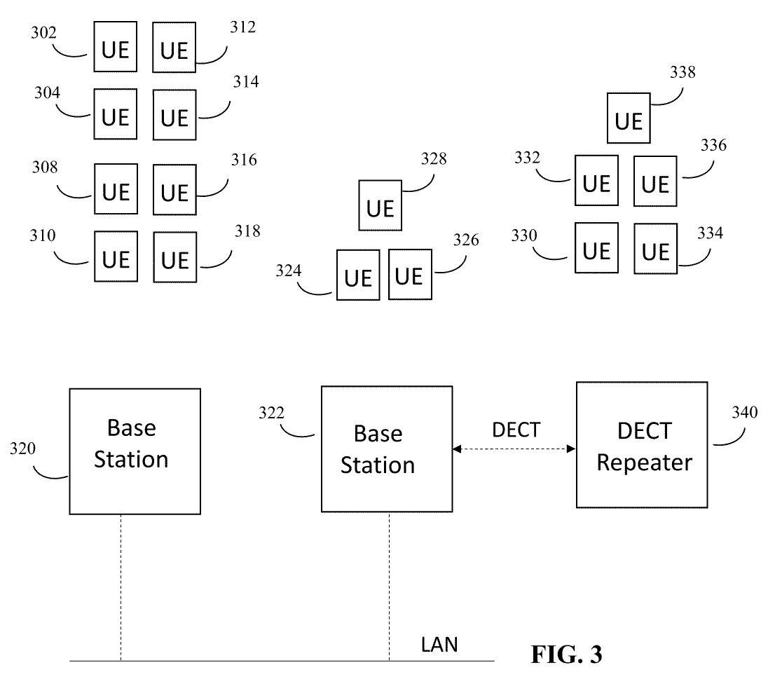

FIG. 3 depicts a multicell system with base station 322 configured to communicate with a DECT repeater 340. As depicted, the multicell DECT system comprises a first base station 320 and a second base station (base station 322), both interconnected via a wired local area network (LAN) connection. Each base station 320 and 322 has a maximum capacity for supporting a limited number of concurrent voice and/or data calls.

In FIG. 3, a first base station 320 is depicted as connecting to eight active calls via eight DECT handsets 302-318. These eight active calls represent the maximum number of concurrent calls that this particular base station can support simultaneously. Each call is established over a cordless telecommunication frequency band to establish a dedicated DECT wireless communication link between the base station 320 and the respective DECT handset 302-318. The maximum number of concurrent calls that can be supported may vary, such as from five to twelve. The first base station 320 may be connected to other base stations, such as the depicted second base station 322, via a wired local area network (LAN).

The second base station 322 is connected to the DECT repeater 340 via DECT wireless communication link. The DECT repeater 340 is a device that extends the coverage area of the second base station 322 by relaying DECT transmissions between the base station and DECT handsets that may be outside the direct range of the base station's transceiver. Like the base stations, the DECT repeater 340 has a limited maximum capacity for supporting concurrent calls.

In the depicted arrangement, the DECT repeater 340 is shown connecting to five concurrent calls via five DECT handsets 330-338. These five concurrent calls represent the maximum number of concurrent calls that this particular repeater can support. Each call between the five handsets 330-338 and the DECT repeater 340 is established over a dedicated DECT wireless communication link. The same five concurrent calls are then connected via the DECT repeater 340 to the second base station 322 over the DECT wireless link between the repeater 340 and the base station 322.

Additionally, the second base station 322 is shown connecting directly to three concurrent calls via three wireless DECT handsets 324-328, without the involvement of the repeater 340. Each of these three calls is established using a cordless telecommunication frequency band over a dedicated DECT wireless communication link between the base station 322 and the respective DECT handsets 324-328.

While the second base station 322 has a maximum capacity of supporting eight concurrent calls, in the depicted scenario, it can only directly handle three concurrent calls (via handsets 324-328) because the other five concurrent calls (via handsets 330-338) are being relayed to the base station 322 through the DECT repeater 340. Thus, in combination, these eight concurrent calls (three direct and five relayed) reach the total maximum concurrent call capacity that the second base station 322 can support.

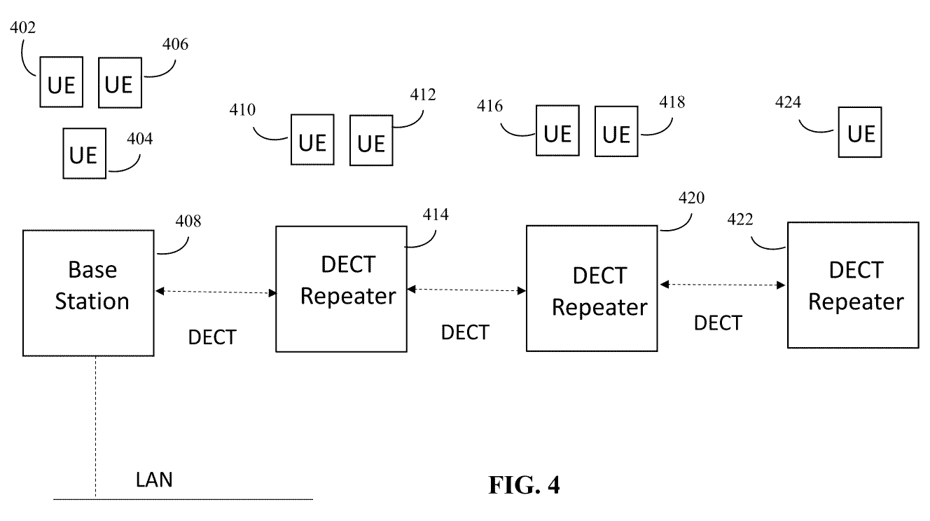

FIG. 4 depicts a multicell DECT system with a daisy-chained configuration of repeaters 414, 420, and 422. The number of repeaters may vary, but is typically limited to a specific number (e.g., 3) due to capacity constraints. A base station 408 may be connected via a wired LAN to other base stations (not shown). In the depicted arrangement, the base station 408 can support up to eight concurrent voice and/or data calls.

The base station 408 is shown directly connected to three concurrent calls via DECT handsets 402-406. Each of these calls is established over a dedicated DECT wireless communication link between the base station 408 and the respective DECT handset 402-406.

Additionally, the base station 408 is connected to a first DECT repeater 414 via a DECT wireless communication link. In this arrangement, each DECT repeater can support up to five concurrent DECT calls. The first DECT repeater 414 is depicted as connecting to two concurrent calls via DECT handsets 410 and 412, with each call established over a dedicated DECT wireless communication link between the repeater and the respective handset.

The first DECT repeater 414 is further connected to a second DECT repeater 420 via a DECT wireless communication link. The second DECT repeater 420 is shown connecting to two concurrent calls via DECT handsets 416 and 418, with each call established over a dedicated DECT wireless link. Additionally, the second DECT repeater 420 is connected to a third DECT repeater 422 via a DECT wireless link.

The third DECT repeater 422 is depicted as connecting to a single concurrent call via a DECT handset 424, with the call established over a dedicated DECT wireless communication link between the repeater and the handset.

Collectively, the first DECT repeater 414, second DECT repeater 420, and third DECT repeater 422 form a daisy-chained configuration, in which each concurrent call is connected to the preceding repeater in the chain via a DECT wireless communication link. Thus, the single concurrent call via device 424 is connected via the third DECT repeater 422 to the second DECT repeater 420, which then connects this call, along with the two concurrent calls it receives directly via handsets 416 and 418, to the first DECT repeater 414.

Consequently, the first DECT repeater 414 receives a total of five concurrent calls: two calls directly via handsets 410 and 412, and three calls connected via the second DECT repeater 420. Since this is the maximum number of concurrent calls that a repeater can handle in this arrangement, no additional concurrent calls can be added to any of the other repeaters in the daisy chain (i.e., the second repeater 420 and the third repeater 422). This inherent limitation in daisy-chained repeater configurations significantly reduces the overall capacity of the DECT system when expanding the coverage range through the addition of repeaters.

Furthermore, the first DECT repeater 414 connects the five concurrent calls (via handsets 410, 412, 416, 418, and 424) to the base station 408. Thus, the base station 408 receives a total of eight concurrent calls: three calls directly via handsets 402-406, and five calls connected via the first DECT repeater 414. Since this is the maximum number of concurrent calls that the base station 408 can handle, no additional concurrent calls can be added to the base station 408, further limiting the overall capacity of the DECT system.

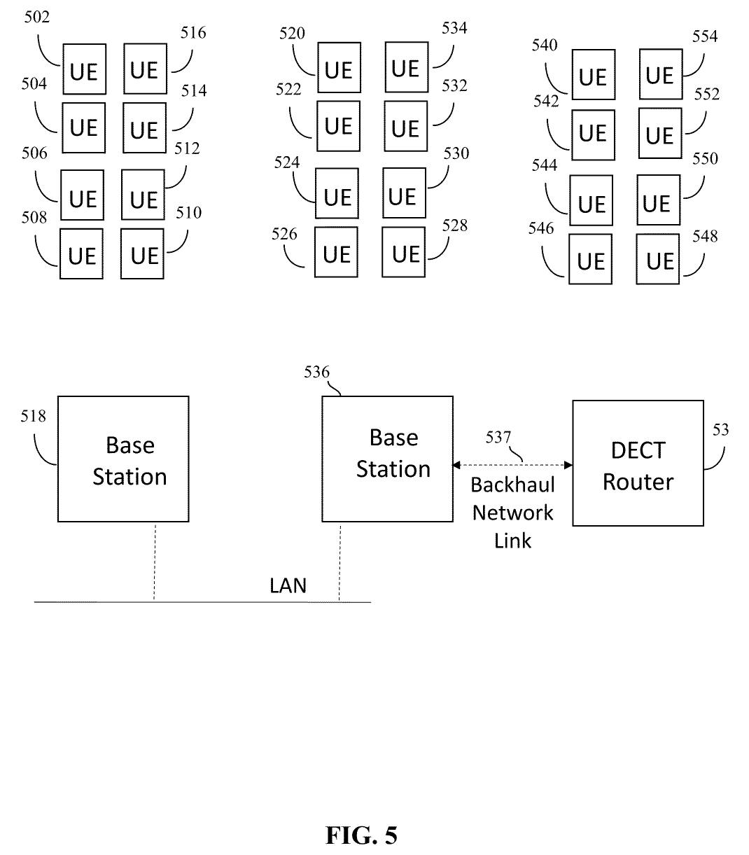

FIGS. 5 depicts an embodiment of a DECT multicell system comprising a base station 536 configured to communicate with a DECT router 538 via a backhaul network.

As depicted, the multicell DECT system comprises a first base station 518 and a second base station (base station 536), both interconnected via a wired local area network (LAN) connection. Each base station 518 and 536 has a maximum capacity for supporting concurrent voice and/or data calls.

In the embodiment shown in FIG. 5, the first base station 518 is depicted as being connected to eight active calls via eight handsets 502-516. The eight active calls represent the maximum number of concurrent calls that this particular base station can support. Each call is established using a cordless telecommunication frequency band over a dedicated DECT wireless communication link between the base station 518 and the respective handsets 502-516. In other embodiments the maximum number of concurrent calls that can be supported may vary such as from five to twelve.

The second base station 536 is connected to the DECT router 538 via a backhaul network link 537. The DECT router 538 is a router device that extends the coverage area of the second base station 536 via communicating using a backhaul network. This network is referred to as a “backhaul” network because it provides a set of communication links which are used specifically for the purpose of transmitting and receiving a set of DECT channels via an independent radio path which does not usurp any of the DECT wireless communication channels which are used by the base station to communicate with the wireless handsets. The backhaul network link 537 may be implemented using various wireless communication technologies: cordless telecommunication, cordless telecommunication NR+, BLE, 900 MHz, 2.4 GHz, and 5.8 GHz FHSS. In embodiments, the backhaul network link 537 may be implemented as a wired backhaul network link such as through fiber optics or Ethernet.

Like the base stations, the DECT router 538 has a limited maximum capacity for supporting concurrent calls. In the depicted embodiment, the DECT router 538 is shown connecting to eight concurrent calls via eight handsets 540-554. The eight concurrent calls represent the maximum number of concurrent calls that the DECT router can support in the example depicted. Each call between the eight handsets 540-554 and the DECT router 538 is established using a cordless telecommunication frequency band over a dedicated DECT wireless communication link. The same eight concurrent calls are then connected via the DECT router 538 to the second base station 536 over the over backhaul network link 537 connecting the DECT router 538 and the second base station 536.

Additionally, the second base station 536 is shown connecting directly to eight concurrent calls via eight wireless DECT handsets 520-534 over DECT wireless communication links. In contrast to the repeater 340 depicted in FIG. 3, the second station 536 in this embodiment is able to connect to its maximum of eight concurrent calls over DECT communication links while also extending its range using the DECT router 538. This is because sending the calls between the second base station 536 and the DECT router 538 over the backhaul network link 537 allows each to reach the respective maximum number of concurrent calls independently, instead of being limited to the capacity of the base station alone. For example, if a base station can only connect to a maximum of eight concurrent calls, and a repeater is used to connect to three concurrent calls, then the base station can only connect to a maximum of five concurrent calls. Thus, unlike the arrangements depicted in FIGS. 3 and 4, which use DECT repeaters to extend the range of just a few calls, the DECT router has the same number of channels as the base station and all of these channels are connected to the base station. Moreover, the base station itself can use all of its available channels (e.g., 8 channels) without sacrificing any of the DECT channels to provide a link to the repeater, resulting in a total of 16 channels. Therefore, a DECT system using a base station in conjunction with a DECT router provides a significantly higher number of channels than an implementation using a base station in conjunction with a repeater.

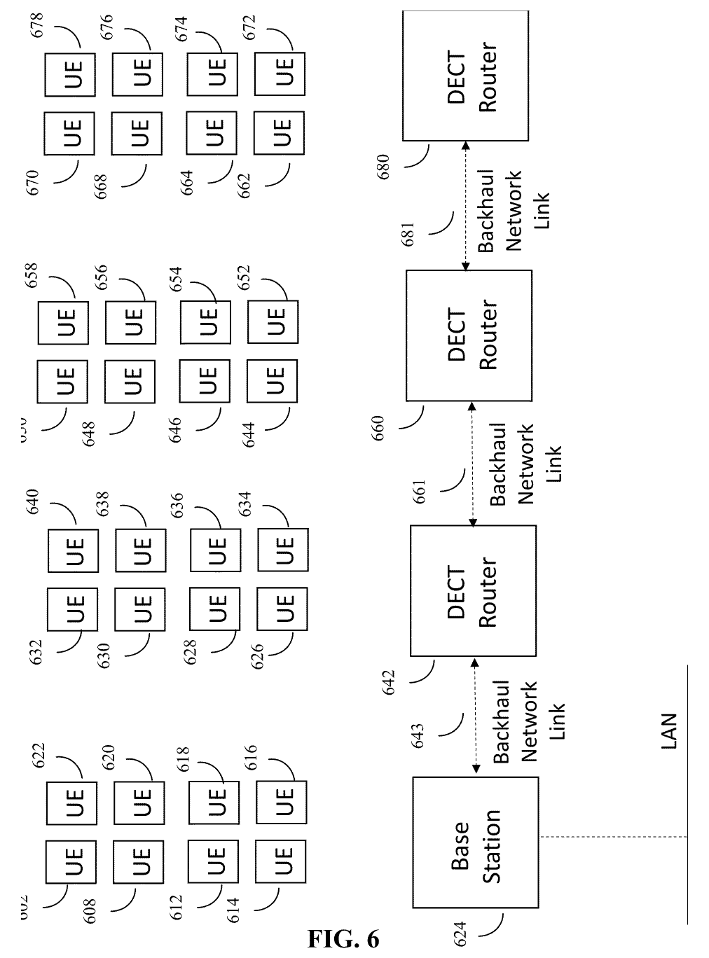

FIG. 6 depicts an embodiment of a multicell DECT system with a daisy-chained configuration of DECT routers 642, 660, 680 connected to a base station 624 via a backhaul network. As depicted, the base station 624 may be connected to other base stations (not shown) via a wired LAN.

The base station 624 is shown directly connected to eight concurrent calls via DECT handsets 602-622. Each of these calls is established over a dedicated DECT wireless communication link between the base station 624 and the respective DECT handset 602-622. In the depicted embodiment, the base station 624 has a maximum capacity for supporting up to eight concurrent voice and/or data calls.

Additionally, the base station 624 is directly connected to a first DECT router 624 via the backhaul network, e.g., via a backhaul network link 643. In this embodiment, each DECT router has a maximum capacity for supporting up to eight concurrent DECT calls. A first DECT router 642 is depicted as connecting to eight concurrent calls via DECT handsets 626-640, with each call established over a dedicated DECT wireless communication link between the router and the respective device.

The first DECT router 642 is further connected to a second DECT router 660 via a backhaul network link 661. The second DECT router 660 is shown connecting to eight concurrent calls via DECT handsets 644-658, with each call established over a dedicated DECT wireless link. Additionally, the second DECT router 660 is connected to a third DECT router 680 via a backhaul network link 681.

In embodiments, the backhaul network links 643, 661, and 681 may be implemented using various wireless communication technologies: cordless telecommunication, cordless telecommunication NR+, BLE, 900 MHz, 2.4 GHz, and 5.8 GHz FHSS. In other embodiments, the backhaul network links 643, 661, and 681 may be wired connections such as through fiber optics or Ethernet.

A third DECT router 680 is depicted as connecting to eight concurrent calls via DECT handsets 662-678 with the call established over a dedicated DECT wireless communication link between the DECT router 680 and the eight handsets 662-678.

Collectively, the first DECT router 642 second DECT router 660, and third DECT router 680 form a daisy-chained configuration, in which each concurrent call is connected to the preceding router in the chain via a backhaul network link. Unlike the arrangements depicted in FIGS. 3 and 4, which use DECT repeaters to extend the range of just a few calls, the DECT routers (642, 660, and 680) each have the same number of channels as the base station and all of these channels are connected to the base station. Moreover, the base station 624 itself can use all of its available channels (e.g., 8 channels) without sacrificing any of the DECT channels to provide a link to the repeater, resulting in a total of 32 channels. Therefore, a DECT system using a base station in conjunction with a daisy-chained configuration of DECT routers provides a significantly higher number of channels than an implementation using a base station in conjunction with repeaters. This is because each DECT router is linked through the backhaul network and thus are able to connect the calls to the other DECT routers without affecting the maximum number of handsets that the other DECT router can connect to. Similarly, the base station 624 is able to connect to the daisy-chain configuration of DECT routers without limiting its ability to connect to its maximum number of DECT handsets. This is again because the base station 624 is connected to the DECT routers 642, 660, 680 through the backhaul network.

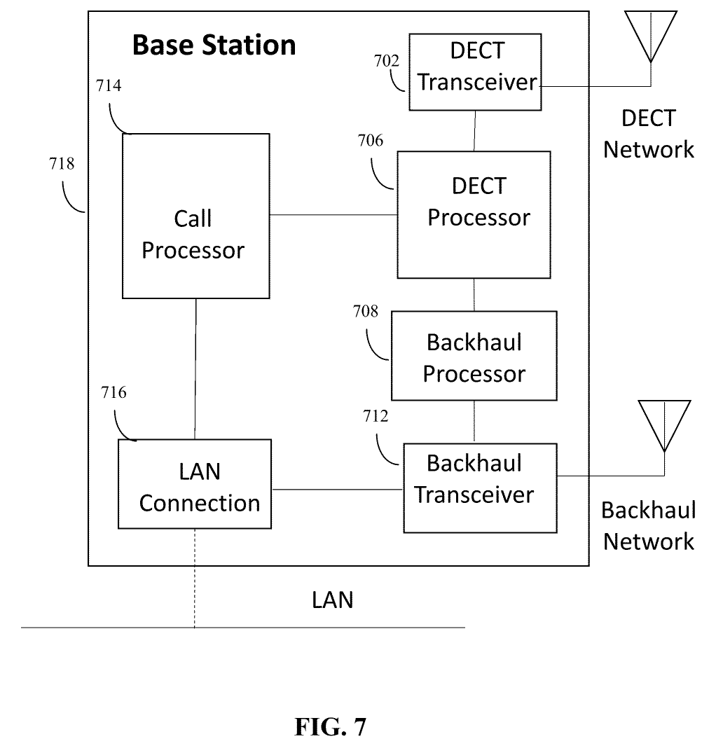

FIG. 7 depicts an embodiment of a base station 718 configured to connect to DECT routers via a backhaul network.

The base station 718 includes a DECT processor 706 and DECT transceiver 702 for enabling wireless voice and data communication with a plurality of DECT portable handsets. The DECT processor 706 implements the DECT protocol stack and air interface defined in the DECT standardized specifications. It handles functions such as establishing and managing DECT links and connections, authenticating and ciphering data, performing channel selection and handovers, error control, and formatting voice and data for transmission over the DECT air interface.

The DECT transceiver 702 is operatively coupled to the DECT processor 706 and comprises RF transceiver circuitry operating in the DECT frequency bands for transmitting and receiving DECT RF signals. It includes a transmitter for modulating and upconverting the formatted DECT data from the DECT processor 706 to the DECT RF frequency band and transmitting it over the DECT air interface. It also includes a receiver for downconverting received DECT RF signals to baseband and demodulating the data for processing by the DECT processor 706.

The DECT transceiver 702 has a wireless range for connecting to and communicating with the DECT handsets within the coverage area. The DECT processor 706 and transceiver 708 support mobility by enabling call handover between the handsets and the base station 718 as the handsets move within the coverage area.

The DECT base station 718 also comprises a call processor 714. The call processor 714 is operatively connected to the LAN Connection 716, enabling it to communicate with other DECT base stations over the wired local area network to handle and process calls. In embodiments, the LAN Connection 716 can include an Ethernet connection (e.g., 10BASE-T, 100BASE-TX, or Gigabit Ethernet), or any other proprietary or standard-based wired LAN interface. The call processor 714 implements a full SIP protocol stack for processing SIP request and response messages. It supports various SIP methods, including INVITE for session initiation, ACK for confirming session initialization, BYE for terminating a session, REGISTER for registering contact information, and others.

When operating in the role of a SIP User Agent Client (UAC), the call processor 714 can initiate VoIP communication sessions with other DECT base stations over the LAN by sending SIP INVITE requests. These INVITE requests include Session Description Protocol (SDP) messages for negotiating audio codecs and establishing media streams. Upon receiving a successful response, the call processor 714 can send an ACK request to confirm the session establishment.

Conversely, when operating in the role of a SIP User Agent Server (UAS), the call processor 714 can receive INVITE requests from other DECT base stations over the LAN Connection 716 and respond accordingly to establish incoming VoIP sessions. It can also handle session modifications by exchanging re-INVITE requests and responses, and terminate established sessions by sending or receiving BYE requests.

The call processor 714 is also operatively coupled to the DECT processor 706, which handles the DECT air interface, codec negotiation, and interfacing with DECT portable handsets. For outgoing calls, the call processor 714 acts as a UAC, initiating a SIP INVITE request over the LAN Connection 716 to establish a VoIP session with another DECT base station. Once the session is established, the call processor 714 works with the DECT processor 706 to map the outgoing call from a DECT handset to the established VoIP session over the LAN.

For incoming calls, the call processor 714 acts as a UAS, receiving a SIP INVITE request over the LAN Connection 716 from another DECT base station. After responding to the INVITE and establishing the VoIP session, the call processor 714 collaborates with the DECT processor 706 to map the incoming call to a DECT handset associated with the base station.

The call processor 714 supports secure communication by providing encryption and authentication through Transport Layer Security (TLS) and Secure Real-Time Transport Protocol (SRTP). It also manages Quality of Service (QoS) by prioritizing voice packet transmission over the LAN Connection 716.

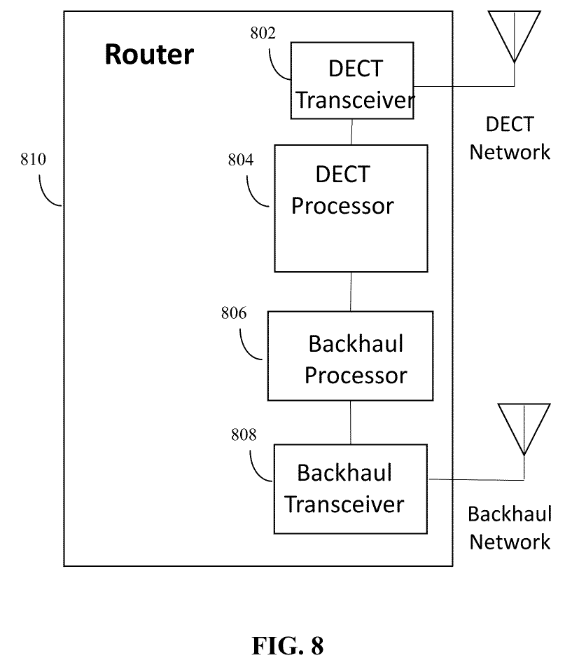

The base station 718 further includes a backhaul processor 708 and backhaul transceiver 712 for enabling wireless voice and data communication over a backhaul network with a DECT router (e.g., FIG. 8). The backhaul processor 708 includes a network interface for connecting to a backhaul network link of the backhaul network.

The backhaul transceiver 712 can be configured to communicate using any one of the following communication technologies: cordless telecommunication, cordless telecommunication NR+, BLE, 900 MHz, 2.4 GHz, and 5.8 GHz FHSS. In embodiments, the backhaul transceiver 712 and DECT transceiver 702 are physically and/or functionally as an integrated transceiver. As discussed above, the backhaul transceiver 712 is configured to transmit and receiver wireless voice and data communication over the backhaul network link to a DECT router. The backhaul transceiver 712 has a coverage area in which it can accurately transmit and receives data from the respective DECT router.

The backhaul processor 708 is operatively coupled to the backhaul transceiver 712 and configured to control transmitting and receiving of the wireless voice and data packets received by the backhaul transceiver 712. When receiving calls, the backhaul processor 708 can be configured to extract the encoded voice information received from over the backhaul network. In embodiments, the backhaul processor 708 is operatively coupled with the DECT processor 706 and/or the call processor 714. Data exchanged between the DECT processor 706 and/or the call processor 714 and the backhaul processor 708 can be reformatted to suit the appropriate needs of the respective processor.

For example, the backhaul processor 708 can packetize voice traffic from sources such as VoIP streams received from the DECT processor 706 or call processor 714 into backhaul voice packets using suitable encapsulation. The backhaul processor 708 may also handle compression, packet header compression, encryption, silence suppression, and jitter buffering to optimize bandwidth utilization over the backhaul network links.

When receiving call information, the backhaul processor 708 receives backhaul data packets containing voice, data, control and management traffic over the backhaul network interface. It authenticates and decrypts the packets if encrypted, and then de-encapsulates the payloads based on the backhaul protocol framing. The extracted payloads are then passed to the appropriate processor such as the control processor 714 or DECT processor 706.

In embodiments, the backhaul transceiver 712 may be configured to communicate over a wired backhaul network link. In the wired connection, the backhaul processor 708 can implement the required backhaul protocol, framing, and addressing to generate the backhaul packets based on the type of backhaul link, for example fiber links, general routing encapsulation over Ethernet, or other standardized or proprietary protocols.

FIG. 8 depicts a DECT router 810 configured to connect to a base station and other DECT routers via a backhaul network. The router 810 includes a DECT processor 804 and DECT transceiver 802 for enabling wireless data communication with a plurality of client devices, e.g., handsets. The DECT processor 804 implements the wireless networking protocol stack and interfaces defined in the relevant specifications. It handles functions such as establishing and managing wireless links and connections, authenticating and encrypting data, performing channel selection and handoffs, error control, and formatting data for transmission over the wireless interface.

The DECT transceiver 802 is coupled to the DECT processor 804 and comprises RF transceiver circuitry operating in the designated wireless frequency bands for transmitting and receiving RF signals. It includes a transmitter for modulating and upconverting the formatted data from the DECT processor 804 to the RF frequency band and transmitting it over the DECT wireless communication links. It also includes a receiver for downconverting received RF signals to baseband and demodulating the data for processing by the DECT processor 804. The DECT transceiver 802 has a wireless range for connecting to and communicating with the client devices, e.g., handsets, within the coverage area. The DECT processor 804 and DECT transceiver 802 support mobility by enabling seamless handoffs between client devices and the router 810 as the devices move within the coverage area.

The DECT router 810 further includes a backhaul processor 806 and backhaul transceiver 808 for enabling wireless voice and data communication over a backhaul network with another DECT router or a base station. The backhaul processor 806 includes a network interface for connecting via the backhaul network. The backhaul transceiver 808 can be configured to communicate using any one of the following communication technologies: cordless telecommunication, cordless telecommunication NR+, BLE, 900 MHz, 2.4 GHz, and 5.8 GHz FHSS. In embodiments, the backhaul transceiver 808 may be configured to communicate over a wired backhaul network link. In embodiments, the backhaul transceiver 808 and DECT transceiver 802 are physically and/or functionally as an integrated transceiver. As discussed above, the backhaul transceiver 808 is configured to transmit and receiver wireless voice and data communication over the backhaul network to a DECT router. The backhaul transceiver 808 has a coverage area in which it can accurately transmit and receives data from the respective router.

The backhaul processor 806 is operatively coupled to the backhaul transceiver 808 and configured to control transmitting and receiving of the wireless voice and data packets received by the backhaul transceiver 808. When transmitting calls, the backhaul processor can be configured to encode voice information received via the DECT transceiver 802.

For example, the DECT transceiver 802 may connect to a DECT handset over a DECT communication link. The call may be processed by the DECT processor 804 and passed to the backhaul processor 806. The backhaul processor 806 may encode the data packets and send them over the backhaul network to a base station (e.g., FIG. 7) or another DECT router over the backhaul network.

For a narrowband call via DECT wireless communication link, a 32 kbps, G.726 codec is typically used in the communication, requiring one duplex channel. In contrast to this, the backhaul processor 806 can use a much lower data rate to transfer narrowband voice data by using a high-compression codec such as OPUS. This means that the backhaul processor 806 can send multiple concurrent calls over the backhaul network with less bandwidth.

Although examples herein describe DECT systems and methods, disclosed embodiments may encompass or relate to telecommunications systems and methods that use other types of wireless communication or other wireless protocols.

The claimed software elements can be realized on a variety of telecommunications systems or subsystems. The following description, in conjunction with the disclosed embodiments described in the foregoing, provides representative, non-limiting examples of potential telecommunications systems or subsystems that could be used to execute the claimed software elements.

At a high level, a telecommunications system or subsystem typically includes, but is not limited to, communication devices, networks, base stations, servers, and a variety of other hardware and software components. Communication devices may include a broad range of devices such as cordless telephones, mobile phones, smartphones, computers, tablets, and other types of devices capable of sending and receiving communication signals. These devices usually include at least one processor, memory, a user interface (such as a display, keyboard, or touch screen), and a network interface for connecting to a network.

The network component of a telecommunications system or subsystem can take various forms, including multicell systems, e.g., Digital Enhanced Cordless Telecommunications (DECT), public switched telephone networks (PSTN), the Internet, mobile networks (e.g., 3G, 4G, 5G), local area networks (LAN), wide area networks (WAN), and others. Base stations and/or servers are also commonly part of telecommunications systems, facilitating the storage, processing, and exchange of data. Like the aforementioned communication devices, these elements generally include a processor and memory for executing software applications, as well as network interfaces for communicating with the network and other devices.

Software elements in the telecommunications system may include operating systems, device drivers, networking software, applications, and other types of software. These software elements can be executed on communication devices, base stations, servers, or other hardware components of the telecommunications systems or subsystems. The claimed software elements may be embodied as computer program code that is executed on one or more of the hardware components of the telecommunications system or subsystem. This code could be stored on a non-transitory computer-readable medium that is part of the communication device, base station, server, or other component, or it could be stored on an external storage device, network storage, or cloud storage.

A computer-readable or machine-readable storage medium may be any electronic, magnetic, optical, or other physical storage device that contains or stores executable instructions. Such a medium may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 24 may be a non-transitory storage medium, where the term "non-transitory" does not encompass transitory propagating signals. A computer-readable or machine-readable medium may be encoded with executable instructions, for example, instructions for performing methods in accordance with the disclosure.

The foregoing detailed description has presented various implementations of the devices and/or processes through the use of block diagrams, schematics, and illustrative examples. As such block diagrams, schematics, and examples include one or more functions and/or operations, it should be understood by those skilled in the art that each function and/or operation within these block diagrams, flowcharts, or examples can be implemented individually and/or collectively by employing a wide range of hardware, software, firmware, or any combination thereof. It should also be recognized by those skilled in the art that the methods or algorithms described herein may incorporate additional steps, may exclude some steps, and/or may execute steps in an order different from the one specified. The various implementations described above can be combined to create additional implementations.

These modifications and other changes can be made to the implementations in light of the above-detailed description. Generally, the terms used in the following claims should not be construed to limit the claims to the specific implementations disclosed in the specification and the claims. Instead, they should be interpreted to encompass all possible implementations, along with the full scope of equivalents to which such claims are entitled. Consequently, the claims are not limited by the disclosure but are intended to cover all possible implementations within their scope.

What is claimed is:

1. A digital cordless telecommunication system for communicating with digital cordless telecommunication handsets, the system comprising:
a first base station comprising:
a first transceiver configured to transmit and receive voice and data packets, using a cordless telecommunication frequency band, between the first base station and a first set of handsets within a coverage area of the first base station, the first base station providing up to a defined maximum number of cordless telecommunication handset connections,
a second transceiver configured to transmit and receive the voice and data packets, via a backhaul network, to at least one other base station configured to transmit and receive the voice and data packets using the cordless telecommunication frequency band,
one or more processors operatively coupled to the first transceiver and the second transceiver to control transmitting and receiving of the voice and data packets by the first transceiver and the second transceiver, and
a call control processor operatively coupled to said one or more processors, the call control processor controlling communication between the first base station and a local area network (LAN).

2. The system of claim 1, wherein the second transceiver of the first base station is configured to wirelessly transmit and receive the voice and data packets via the backhaul network using a different frequency band than the cordless telecommunication frequency band.

3. The system of claim 1, wherein the second transceiver of the first base station is configured to wirelessly transmit and receive the voice and data packets via the backhaul network using a communication technology different from a communication technology used by the first transceiver of the first base station.

4. The system of claim 1, wherein said one or more processors of the first base station comprise:
a first processor operatively coupled to the first transceiver of the first base station and configured to control transmitting and receiving of the voice and data packets by the first transceiver of the first base station; and
a second processor operatively coupled to the second transceiver of the first base station and configured to control transmitting and receiving of the voice and data packets by the second transceiver of the first base station.

5. The system of claim 1, wherein the second transceiver of the first base station is configured to communicate using any one of the following communication technologies: cordless telecommunication, cordless telecommunication NR+, BLE, 900 MHz, 2.4 GHz, and 5.8 GHz FHSS.

6. The system of claim 1, wherein said defined maximum number of cordless telecommunication handset connections is between 5-12., inclusively.

7. The system of claim 1, wherein said one or more processors use a codec to compress and decompress the voice and data packets.

8. The system of claim 1, wherein the call control processor is a session initiation protocol (SIP) processor.

9. The system of claim 1, wherein the first transceiver of the first base station and the second transceiver of the first base station are formed physically and/or functionally as an integrated transceiver.

10. The system of claim 1, further comprising at least a second base station configured to transmit and receive the voice and data packets, using the cordless telecommunication frequency band, between said at least second base station and a corresponding set of handsets within a coverage area of said at least second base station, said at least second base station being further configured to transmit and receive the voice and data packets, using the backhaul network, between the first base station and said at least second base station.

11. The system of claim 10, wherein the first base station provides connectivity to any handset in the first set of handsets and said corresponding set of handsets.

12. The system of claim 10, wherein the first base station is configured to:
connect to a target handset of said corresponding set of handsets via the backhaul network and said at least second base station when the target handset is within the coverage area of said at least second base station, and
connect to the target handset using the cordless telecommunication frequency band when the target handset moves within the coverage area of the first base station.

13. The system of claim 10, wherein the second transceiver of the first base station is configured to transmit and receive the voice and data packets via the backhaul network using a wired connection between the first base station and said at least second base station.

14. The system of claim 10, wherein said at least second base station provides up to a defined maximum number of cordless telecommunication handset connections.

15. The system of claim 14, wherein the first base station provides a total number of handset connections up to the defined maximum number of cordless telecommunication handset connections of the first base station plus the defined maximum number of cordless telecommunication handset connections of said at least second base station.

16. The system of claim 10, wherein said one or more processors of the first base station are further configured to compress and decompress voice and data packets for communication between the second transceiver of the first base station and said at least second base station via the wireless backhaul network.

17. The system of claim 10, wherein said at least second base station comprises a plurality of base stations configured to transmit and receive the voice and data packets, using the cordless telecommunication frequency band, between each base station of said plurality of base stations and a respective corresponding set of handsets within a coverage area of each base station of said plurality of base stations, each base station of said plurality of base stations being further configured to transmit and receive the voice and data packets, using the backhaul network, between each base station of said plurality of base stations and the first base station.

18. The system of claim 10, wherein said at least second base station comprises a plurality of base stations connected in series and configured to transmit and receive the voice and data packets, using the cordless telecommunication frequency band, between each base station of said plurality of base stations and a respective corresponding set of handsets within a coverage area of each base station of said plurality of base stations, each base station of said plurality of base stations being further configured to transmit and receive the voice and data packets, using the backhaul network, between each base station of said plurality of base stations and a neighboring one of said plurality of base stations.

19. The system of claim 10, wherein said at least second base station comprises:
a first transceiver configured to transmit and receive voice and data packets, using the cordless telecommunication frequency band, between said at least second base station and said corresponding set of handsets,
a second transceiver configured to transmit and receive the voice and data packets, via the backhaul network, to at least one other base station configured to transmit and receive the voice and data packets using the cordless telecommunication frequency band, and
one or more processors operatively coupled to the first transceiver and the second transceiver to control transmitting and receiving of the voice and data packets by the first transceiver and the second transceiver.

20. The system of claim 19, wherein said at least second base station further comprises a call control processor operatively coupled to said one or more processors of said at least second base station, the call control processor of said at least second base station controlling communication between said at least second base station and a local area network (LAN).
